(19) United States
(12) Patent Application Publication
(10) Pub. No.: US 2018/0060506 A1
(43) Pub. Date: Mar. 1, 2018

(54) SYSTEMS AND METHODS FOR GENERATING CUSTOM USER EXPERIENCES BASED ON PROCESSED CLAIMS DATA

(71) Applicant: ViMedicus, Inc., Chicago, IL (US)

(72) Inventors: Thomas CHURCHWELL, Chicago, IL (US); Robert CHURCHWELL, Chicago, IL (US); Stephen WASKO, Chicago, IL (US); Katharine FRANCIS, Chicago, IL (US); Kellie SCHOEN, Chicago, IL (US); Corey CAMPBELL, Chicago, IL (US); Sally ROSENTHAL, Chicago, IL (US)

(21) Appl. No.: 15/686,734

(22) Filed: Aug. 25, 2017

Related U.S. Application Data
(60) Provisional application No. 62/379,256, filed on Aug. 25, 2016.

(51) Int. Cl. G06F 19/00

(52) U.S. Cl. CPC G06F 19/328; G06F 19/325; G06F 19/3406

(57) ABSTRACT

Aspects of the present disclosure involve various algorithms and mechanisms to automatically process large amounts of claims data in real-time and automatically identify patients as potential participants for inclusion into a health care and behavior modification treatment regime based on the processed claims data.

### CROSS REFERENCE TO RELATED APPLICATION

This application claims the benefit of U.S. provisional application No. 62/379,256 titled “System and Method for Health Improvement”, filed Aug. 25, 2016, and which is incorporated herein in its entirety by reference.

### TECHNICAL FIELD

Aspects of the present disclosure relate to computing devices and hardware used in data aggregation and processing of medical claims and other health-related data.

### BACKGROUND

Healthcare providers (such as hospitals, clinics or physicians) typically send claims to healthcare payer institutions to obtain reimbursement for services rendered to a patient. Typically, the claims are sorted, indexed and electronically stored. Automatically processing vast amounts of electronic claims data presents challenges.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a block diagram illustrating a computing architecture for processing claims data to automatically provide content to patients identified for inclusion in a health concern, according to aspects of the present disclosure.

FIG. 2 is a flowchart of an example process for processing claims data, according to aspects of the present disclosure.

FIGS. 3A-3B are example claims data records, according to aspects of the present disclosure.

FIG. 4 is a block diagram illustrating a computing device, according to aspects of the present disclosure.

### DETAILED DESCRIPTION

The healthcare ecosystem—from patients and providers to payers and product developers—has seen ever-growing costs, significantly associated with patients that suffer from multiple chronic medication conditions and illnesses. For example, well-known chronic illnesses include chronic obstructive pulmonary disorder (COPD), congestive heart failure (CHF), obesity, hypertension, chronic pain, asthma, and diabetes. While advances in medicine have improved the life span for patients suffering from such chronic conditions, the medical industry has struggled to reverse the progression of these diseases once a patient has been diagnosed. Furthermore, patients who suffer from one chronic disease often develop additional chronic illnesses. Such a downward cascade can be debilitating to the patient, taxing for providers, and expensive for payers.

In an attempt to resolve such issues, many healthcare related computing systems have been created that attempt to aid patients in their treatment of chronic illnesses and conditions. For example, typical systems involve an application for a mobile device, such as a smart phone having a processor and wireless networking capability that allows users to manage and track treatments of a chronic disease. Further, such systems manage and track treatments of chronic diseases one disease at a time, rather than addressing the conditions that lead to the development of multiple co-morbid chronic diseases. Such systems are data-driven and require users (i.e., patients) to manually input vast amounts of information related to their individual chronic conditions and the system typically recommends disease specific treatment services to the user rather than more broad-based behavioral oriented services that are needed to treat people with multiple chronic diseases. The amount of disparate data needed to identify the multiple chronic disease pattern is extremely difficult to enter manually so that the appropriate multiple chronic disease patterns can be discerned and appropriate treatment recommended.

Moreover, existing systems are unable to process and incorporate both medical claims data and other clinical health data that provide meaningful insight into the constellation of a patient's multiple chronic conditions and overall medical condition. The majority of healthcare providers (physicians, dentists, etc.) obtain payment for medical services provided to a patient from a payer, which is generally a healthcare organization or insurance company administering a plan for the patient's employer. The data that is submitted from the healthcare provider to the payer is generally referred to as a “claim” and includes the information used by a payer for payment of the healthcare provider for the service rendered to a patient. In one specific example, the claim represents a set of data, or an electronic document that identifies: the physician that provided the service, multiple diagnostic codes, a service identification code, the patient, the patient's group and plan number, payer identification, the amount of the claim, co-payment amount, etc., all of which may be maintained in a database, or other type of data structure.

Typical health care computing systems are unable to process claims data appropriately due to the vast amount of information and associated records, disparate data sets, and the systems inability to access claims computing data from other health care systems' claims data storage systems that maintain claims data. Claims computing systems often process a high volume of claims in accordance with dynamic medical policies—but do not have the ability to completely and accurately process such claims data sets, and identifying trends within a complete set of claims and medical data can be cumbersome. Thus, a need exists for a more efficient, complete and cost-effective manner for handling updates and changes to multi-system claims data.

Aspects of the present disclosure solve these specific technical issues by providing a system and method that executes various algorithms to automatically process large amounts of claims data in real-time and automatically identify patients as potential participants for inclusion into a health care and behavior modification treatment regime. More specifically, the claim data has various fields and/or parameters that are processed by the system in conjunction with one or more rules or algorithms that enable the system to identify specific lifestyle change needs and chronic conditions of a patient. Once a lifestyle change need for a given patient has been verified, the patient may be flagged as a potential participant for a treatment regimen, and the system may provide (e.g., via graphical user-interface) customized content (e.g., multimedia content) to the patient that targets the specific aspects of the participants chronic conditions and/or behavior, thereby offering more meaningful and engaging treatment to the user. Since the content is targeted specifically to the user's intrinsic needs, the user is more likely to engage and interact with the content and thereby actively participate in the treatment regimen.

Further, once a patient is flagged as a potential participant for a treatment regimen, and the system may provide (e.g., via graphical user-interface) recommended treatment curriculum (e.g., multimedia content) to a coach or a guide for the patient that is specific to the specific aspects of the participants chronic conditions and/or behavior, thereby allowing the coach to deliver more meaningful and better treatment to the user. Since the content is targeted specifically to the user's intrinsic needs, the content will be better tailored by the coach to the specifically identified user.

In other aspects, the disclosed system may include a mechanism that continuously monitors a user's interactions with the provided content. In one specific example, the system may monitor user interactions occurring at the content and/or graphical user-interfaces that identify decisions made by the user with respect to the user's engagement in the treatment regimen, for use in monitoring the user's progress and so as to present actual behavior-based information to the user for continuous treatment modification thereby creating greater success in achieving health goals.

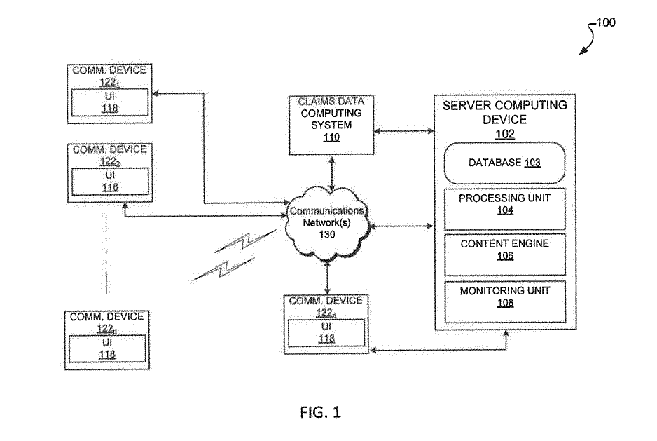

FIG. 1 provides an illustrative example of a computing network 100 that may be used to process claims data to identify participants for a treatment regimen, according to one embodiment. As illustrated, the computing network 100 includes various devices functioning together in the gathering and processing of claims data. In the illustrated embodiment, the computing network 100 includes server computing device 102 that includes a processing unit 104 for processing claims data to identify participants for inclusion in a treatment regimen and automatically identifying custom content for initial inclusion in the treatment regimen. The server computing device 102 further includes a database and/or data store 103 (or some other database architecture including those embodied in a single database or multiple databases of the same or differing platforms) that is used to store, among other information and content, claims data and/or data relating to healthcare content and/or health-care related applications, and data generated from users interacting with graphical user-interfaces generated by the server computing device 102. Alternatively, the claims data may be received from a claims data computing system, for example, located at a health care provider, hospital, physician's office, or other entity involved in processing and maintaining claims data. Thus, the server computing device 102 functionally communicates with the claims computing system 110.

The server computing device 102 includes a content engine 106 that uses the processed claims data to identify participants for inclusion into a behavioral health care program. Additionally, based on the identified participant, the content engine 106 may identify health content for presentation to the identified participant.

The server computing device 102 further includes a monitoring unit 108 that continuously monitors a user's interaction with the content provided by the content engine 106. In some embodiments, the monitoring engine 106 may generate one or more graphical user-interfaces that, as will be described in more detail below, generates various metrics and graphical displays articulating the user's interactions with the provided content.

One or more comm. devices 122₁, 122₂,-122_{N}, functionally communicate with the server computing device 102 using a communications network 130. The one or more comm. devices 122₁, 122₂,-122_{N}, may be may be a personal computer, work station, mobile device, mobile phone, tablet device, processor, and/or other processing device capable of implementing and/or executing processes, software, applications, etc., that includes network-enabled devices and/or software, such as a user-interface 118 for communication over the communications network 130 (e.g., browsing the internet). Additionally, the one or more comm. devices 122₁, 122₂,-122_{N}, may include one or more processors that process software or other machine-readable instructions and may include a memory to store the software or other machine-readable instructions and data.

The communications network 130 may include via or more wireless networks such as, but not limited to one or more of a Local Area Network (LAN), Wireless Local Area Network (WLAN), a Personal Area Network (PAN), Campus Area Network (CAN), a Metropolitan Area Network (MAN), a Wide Area Network (WAN), a Wireless Wide Area Network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, LTE networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols. Network 130 may also include wired networks.

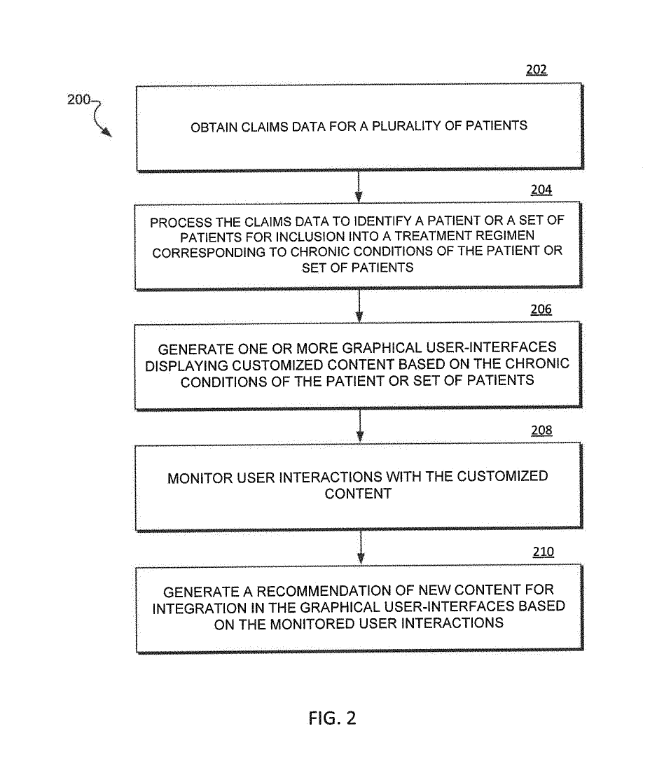

Referring now to FIG. 2 and with reference to FIG. 1, an illustrative process 200 for processing claims data to identify patients for inclusion into a treatment regime is provided. Referring initially to FIG. 2, process 200 begins with obtaining claims data for a plurality of patients, each of which could be identified as a potential participant in a target medical and behavioral treatment regimen. Referring to FIG. 1, claims data may be received by the server computing device 102 from the claims data computing system 110. As explained above, claims data may include data involving reimbursement for services rendered by a primary care doctor, a specialist, a hospital, a medical procedure, and/or the like. In other embodiments, other medical data that is different than the claims data, such as electronic medical record data may be obtained and processed.

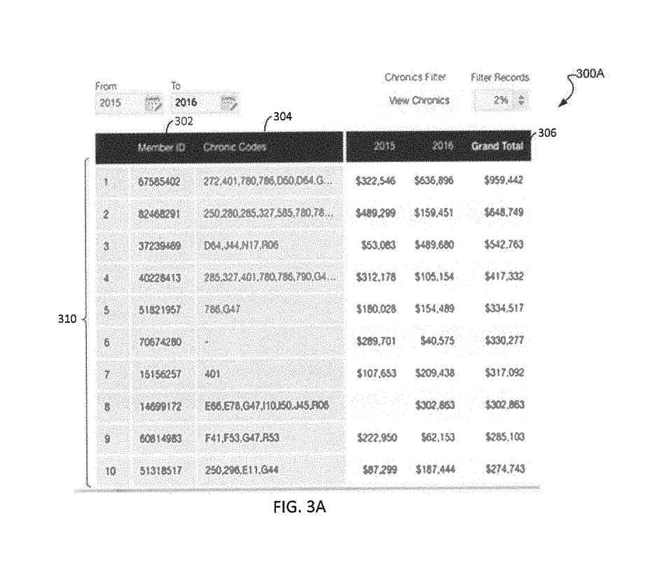

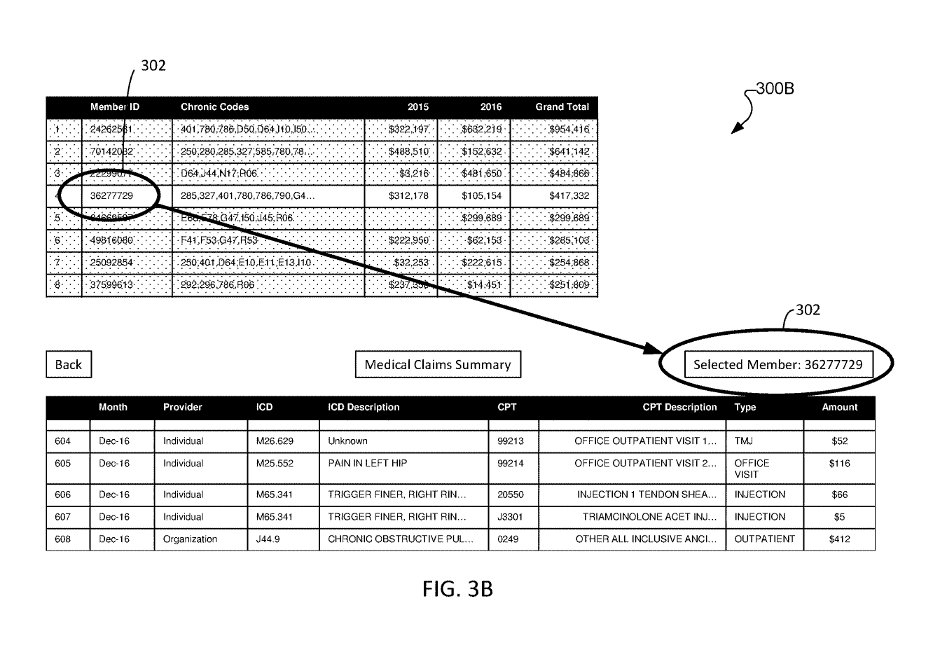

FIG. 3A illustrates an example of claim data in the form of a claims data source 300A, according to one embodiment. As illustrated the data source 300A includes a table identifying a series of columns. In particular, the table includes a member ID column 302 that identifies a medical plan beneficiary. Additionally the table of the data source record 300A includes a chronic codes column 304 that indicates the number and type of chronic conditions which, when taken in combination, indicate whether an individual beneficiary is an appropriate candidate for the medical and behavioral treatment program. Finally, the table of the data source record 300A includes a Grand Total column 306 that defines the total cost to the employer for providing medical services to their health plan beneficiaries associated with such multiple chronic conditions. As further illustrated, the table of the billing record 300A includes one or more lines 310. A line may be a summary of multiple claims for services as aggregated for different individual beneficiaries. Each line includes a specific total amount value for the member ID column 302, chronic codes column 304, and Grand Total column 306.

The obtained claim data is processed to identify specific patients for inclusion into a treatment regimen that is customized according to chronic conditions of that patient (operation 204). FIG. 3B illustrates an example of the processing of claims data to identify those specific patients. As illustrated in the table of 300B, patients are ranked by degree of utilization of healthcare services. Then, within the set of patients with high utilization of healthcare services, an algorithm is used to identify a specific pattern of chronic diseases which contribute to that high utilization. For example, in FIG. 3B, the CPT codes signify the characteristics of the disease diagnoses which drive the patients' healthcare utilization. A unique collection of these CPT codes must be present in order for the patient to be a suitable candidate for the treatment regimen. As a threshold, at least three distinctly different SPT code families must be present for a patient to be considered qualified for the treatment regimen, although other thresholds are contemplated.

Once a particular patient or a set of patients has been identified, custom content is provided to the identified patient or set of patients based on the chronic conditions identified from the processed claims data (operation 206). Referring to FIG. 1, in one specific example, the server computing device 102 may generate various graphical user-interfaces that include interactive elements, such as survey questions, buttons, forms, activity logs, fields, streaming capabilities, selections, inputs, streams, images, etc., and/or charts, for displaying or otherwise presenting content to the patient that involves type of treatment or care corresponding to the set of chronic conditions of the patient. Referring to FIG. 1, the user may interact with the one or more comm. devices 122₁, 122₂,-122_{N} to access the provided custom content.

Referring again to FIG. 2, in some embodiments, the system may monitor, in real-time, a user's interactions with the provided custom content (operation 208). In one specific example, the server computing device 102 may employ the monitoring unit to continuously monitor a user's interactions and participation with the custom content provided in the generated graphical user-interfaces. In one specific example, one or more parameters related to the treatment regimen may be embedded in the graphical user interfaces displaying the custom content to users that track user interactions. The parameter data may be tracked and continuously communicated to the server computing device 102. All of such user interactions and/or parameter data may be stored in the database of server computing device 102.

Based on the user interactions, the system may generate recommendations of new relevant content that may be automatically integrated into the platform and displayed at a user device/client device for user interaction (operation 210). The recommendations may be generated based on the monitoring performed by the server computing device 102.

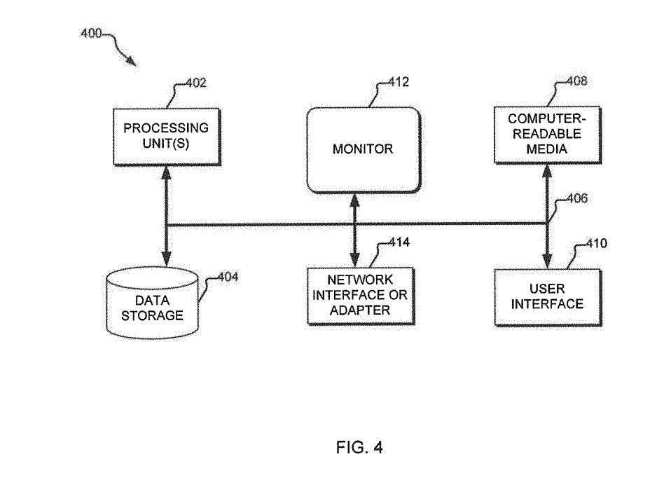

FIG. 4 illustrates an example of a suitable computing and networking environment 400 that may be used to implement various aspects of the present disclosure described in FIGS. 1-2, such as the intelligent recommendation system 102. As illustrated, the computing and networking environment 400 includes a general purpose computing device 400, although it is contemplated that the networking environment 400 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 400 may include various hardware components, such as a processing unit 402, a data storage 404 (e.g., a system memory), and a system bus 406 that couples various system components of the computer 400 to the processing unit 402. The system bus 406 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 400 may further include a variety of computer-readable media 408 that includes removable/non-removable media and volatile/nonvolatile media, but excludes transitory propagated signals. Computer-readable media 408 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 400. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 404 includes computer storage media in the form of volatile/nonvolatile memory such as read only memory (ROM) and random access memory (RAM). A basic input/output system (BIOS), containing the basic routines that help to transfer information between elements within the computer 400 (e.g., during start-up) is typically stored in ROM. RAM typically contains data and/or program modules that are immediately accessible to and/or presently being operated on by processing unit 402. For example, in one embodiment, data storage 404 holds an operating system, application programs, and other program modules and program data.

Data storage 404 may also include other removable/non-removable, volatile/nonvolatile computer storage media. For example, data storage 404 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 4, provide storage of computer-readable instructions, data structures, program modules and other data for the computer 400.

A user may enter commands and information through a user interface 410 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 402 through a user interface 410 that is coupled to the system bus 406, but may be connected by other interface and bus structures, such as a parallel port, game port or a universal serial bus (USB). A monitor 412 or other type of display device is also connected to the system bus 406 via an interface, such as a video interface. The monitor 412 may also be integrated with a touch-screen panel or the like.

The computer 400 may operate in a networked or cloud-computing environment using logical connections of a network interface or adapter 414 to one or more remote devices, such as a remote computer. The remote computer may be a personal computer, a server, a router, a network PC, a peer device or other common network node, and typically includes many or all of the elements described above relative to the computer 400. The logical connections depicted in FIG. 4 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 400 may be connected to a public and/or private network through the network interface or adapter 414. In such embodiments, a modem or other means for establishing communications over the network is connected to the system bus 406 via the network interface or adapter 414 or other appropriate mechanism. A wireless networking component including an interface and antenna may be coupled through a suitable device such as an access point or peer computer to a network. In a networked environment, program modules depicted relative to the computer 400, or portions thereof, may be stored in the remote memory storage device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A system comprising:
a processing device; and
a memory containing one or more instructions, which when executed, cause the processing device to:
obtain claims data from one or more data sources, the claims data describing medical services provided to a plurality of patients;
process the claims data to identify at least one patient for inclusion in a medical treatment regimen and at least one chronic condition corresponding to the patient;
generate one or more graphical user-interfaces for display at a client device, the one or more graphical user-interfaces displaying first content, wherein the first content is associated with the at least one chronic condition;
continuously monitor user-interactions with the first content; and
integrate second content into the graphical user-interfaces based on the monitored user-interactions.

2. The system of claim 1, wherein the processing device is further configured to:
continuously monitor user-interactions with the second content; and
integrate third content into the graphical user-interfaces based on the user-interactions of the second content.

3. The system of claim 1, wherein the claims data is received from a claims data computing system, the method further comprising:
obtaining medical data other than claims data; and
processing the other medical data to determine the at least one patient.

4. The system of claim 1, wherein the claims data includes a table comprising a plurality of columns including at least one of an employee column, a chronic codes column, and a grand total column.

5. The system of claim 1, wherein the computing device is further configured to identify claim data deficiencies and automatically correcting claim data element deficiencies.

6. The system of claim 1, wherein the first content is multimedia content including at least one of audio, video, and images.

7. A method comprising:
obtaining, using a computing device, claims data from one or more data sources, the claims data describing medical services provided to a plurality of patients;
processing, using the computing device, the claims data to identify at least one patient for inclusion in a medical treatment regimen and at least one chronic condition corresponding to the patient;
generating, using the computing device, one or more graphical user-interfaces for display at a client device, the one or more graphical user-interfaces displaying first content, wherein the first content is associated with the at least one chronic condition;
continuously monitoring, using the computing device, user-interactions with the first content; and
integrating, using the computing device, second content into the graphical user-interfaces based on the monitored user-interactions.

8. The method of claim 7, further comprising:
continuously monitor user-interactions with the second content; and
integrating third content into the graphical user-interfaces based on the user-interactions of the second content.

9. The method of claim 7, wherein the claims data is received from a claims data computing system and wherein the at least one computing device is further configured to:
obtain medical data other than claims data; and
process the other medical data to determine the at least one patient.

10. The method of claim 7, wherein the claims data includes a table comprising a plurality of columns including at least one of an employee column, a chronic codes column, and a grand total column.

11. The method of claim 7, wherein the computing device is further configured to identify claim data deficiencies and automatically correcting claim data element deficiencies.

12. The method of claim 7, wherein the first content is multimedia content including at least one of audio, video, and images.

13. A non-transitory computer readable medium encoded with instructions, the instructions, executable by a computing device, comprising:
obtaining claims data from one or more data sources, the claims data describing medical services provided to a plurality of patients;
processing the claims data to identify at least one patient for inclusion in a medical treatment regimen and at least one chronic condition corresponding to the patient;
generating one or more graphical user-interfaces for display at a client device, the one or more graphical user-interfaces displaying first content, wherein the first content is associated with the at least one chronic condition;
continuously monitoring user-interactions with the first content; and
integrating second content into the graphical user-interfaces based on the monitored user-interactions.

14. The non-transitory computer readable medium of claim 13, further comprising:
continuously monitor user-interactions with the second content; and
integrating third content into the graphical user-interfaces based on the user-interactions of the second content.

15. The non-transitory computer readable medium of claim 13, wherein the claims data is received from a claims data computing system, the instructions further comprising:
obtaining medical data other than claims data; and
processing the other medical data to determine the at least one patient.

16. The non-transitory computer readable medium of claim 13, wherein the claims data includes a table comprising a plurality of columns including at least one of an employee column, a chronic codes column, and a grand total column.

17. The non-transitory computer readable medium of claim 13, wherein the computing device is further configured to identify claim data deficiencies and automatically correcting claim data element deficiencies.

18. The non-transitory computer readable medium of claim 13, wherein the first content is multimedia content including at least one of audio, video, and images.
